(19) United States
(12) Patent Application Publication
(10) Pub. No.: US 2025/0192662 A1
(43) Pub. Date: Jun. 12, 2025

(54) SOFT SWITCHING DC-DC CONVERTER

(71) Applicants: JIANPING FAN, Hayward, CA (US); XIAOPING JIN, Hayward, CA (US)

(72) Inventors: JIANPING FAN, Hayward, CA (US); XIAOPING JIN, Hayward, CA (US)

(21) Appl. No.: 18/535,187

(22) Filed: Dec. 11, 2023

(51) Int. Cl. H02M 1/00; H02M 3/158

(52) U.S. Cl. CPC H02M 1/0058; H02M 3/158

(57) ABSTRACT

A soft switching step down DC-DC converter with a center tapped inductor in series with a coupling capacitor to realize zero voltage switching operation and expand the operation duty of the active switch. The soft switching operation eliminates the switching losses associated with hard switching, reducing voltage spikes across the switching devices and switching noise generated by the converter system, and the expanded operation duty reduces the RMS current of the active switch and the associated conduction losses.

### BACKGROUND

### 1. Field of the Invention

The invention is generally related to non-isolated DC-DC converter topology and more particularly to using a center tapped inductor and a coupling capacitor to realize soft switching operation with expanded operation duty cycle to improve the efficiency and reduce switching noise of the converter system.

### 2. Description of the Related Art

In DC-DC converter applications Buck topology is widely used to convert an input voltage to an output voltage lower than the input voltage. The simplest Buck converter circuit uses a control power switch at high side to transfer the input power to the output through an inductor and with a freewheel diode at low side to provide a continuity path for the inductor current. A conceptual circuit of such converter is illustrated in FIG. 1A.

With the increasing needs for higher efficiency, especially at low output voltage, high output current applications, the low side diode is replaced by a switching device such as a MOSFET that turns on and off in complementary manner to the high side switch, to utilize the advantage of lower conduction voltage drop of the device to reduce the conduction losses. A conceptual circuit of this approach is illustrated in FIG. 1B. Such technology is well understood by those skilled in the art, and hence will not be further elaborated herein.

With the rapid growth of scale and complexity of modern electronic system, the power consumption of the systems is also increasing accordingly. Under such circumstances, higher efficiency power converter and higher input voltage, such as 48V for input distribution, are inevitably required to minimize the power losses, heat generation and conductor weight in the power delivery chain. However, with the increasing input voltage such as from 12V to 48V in automotive systems, the losses associated with hard switching, increased RMS current of the active control switch and increased Rdson with higher voltage rating devices etc. will increase dramatically to the extent that direct conversion from 48V to a low voltage output such as 1V or lower becomes a very challenging practice. A commonly proposed approach is to use an intermediate converter to step down the 48V input to an intermedium voltage such as 12V and then convert the intermedium voltage to the target low voltage to supply the load devices.

Obviously, such approach will increase the cost, space and material consumption, and weight of the system, especially in applications like automotive systems, the electronic devices are vastly distributed and thus, multiple intermediate converters are needed for power distribution in the whole system.

### SUMMARY OF THE INVENTION

It is the intention of the present invention to make a single stage power conversion to convert a high input voltage to the low voltage needed for the electronic devices directly to provide a high efficiency, low cost solution for today's market and moving forward to the future. As it is well known in this art, in conventional Buck converter, including synchronous Buck converter operation, the turn-on of the high side power device is a hard switching operation, i.e. the device is turned on at the condition that a voltage, normally equals the input voltage of the converter, is existing across the device. The resultant switching loss is a significant factor affecting the efficiency of the converter, especially at high input to output voltage ratio and high frequency operations.

The disclosed concept herein has provided a circuit topology and corresponding operating method to achieve soft switching operation to turn on the high side switch at zero voltage condition to eliminate the switching losses associated with hard switching, and in the meanwhile, reduce the conduction losses of the high side switch by expanding the duty cycle to yield lower RMS value of the current flowing through the device. In addition, the zero voltage switching operation results in lower switching noise and lower voltage spikes across the high side device, improving the operation robustness of the system and the switching devices.

In one embodiment, a tapped inductor with turns ratio of n, herein n>1 as defined in the detailed description, is utilized in the power delivery path from the switching node to the output. A switching element (or a diode) is deployed from the center tap of the inductor to the power ground, the switching element is turned on when the high side switch is off, to provide a freewheeling path for the inductive current through the inductor section between the center tap and the output terminal, thus allowing the duty cycle of the high side switch to be expanded by n times and the current amplitude of the high side switch lowered by n times, to reduce the conduction losses during the period when high side switch is on.

In one embodiment, a coupling capacitor is connected between the tapped inductor and the switching node, energy is charged to the coupling capacitor when the high side control switch is on and current flows through the capacitor and the tapped inductor to the output. When the high side control switch is turned off and the low side devices are on, the coupling capacitor discharges its energy to the inductor section between the center tap and the terminal connected to the capacitor to deliver the energy to the output through the magnetic coupling effect of the tapped inductor, wherein the tapped inductor is essentially working as an autotransformer to couple the energy from its primary side between the center tap and the coupling capacitor side to the secondary side between the center tap and the output, to deliver power to the output. Furthermore, during this operating period the current in the primary side changes its direction, flowing to the switching node through the coupling capacitor and return through the low side device, thus when the low side device is turned off, the primary current will divert its path to discharge the output capacitance of the high side control switch and flow to the positive terminal of the input, if the high side switch is turned on when its output capacitance is discharged to near zero volt, a zero voltage turn on switching is realized, by such operation the losses associated with hard switching are eliminated.

In one embodiment, the voltage stress of the switch on the center tap of the inductor that carries the full load current during freewheeling period is reduced in accordance to the turns ratio of the tapped inductor, therefore a device with lower voltage rating, and consequently lower on resistance, can be utilized to reduce the conduction losses and further improve the efficiency of the converter, providing significant advantages for applications with high input to output voltage ratios in conjunction with the advantage of soft switching operation achieved by this invention.

In one embodiment, a novel method of the present invention controls the power switches at particular operating state to effectively suppress the output voltage overshoot at load step down transient. At load step down transient, the switch connected to the center tap of the tapped inductor remains off after the high side switch is turned off, and thus preventing the operating mode of the tapped inductor from inductor mode to autotransformer mode, to avoid resultant step increase of the current flowing to the output. In addition, by eliminating the circulating path of the inductive current through the switch on the center tap of the tapped inductor, the circulation of the inductive current goes through the coupling capacitor and thus transferring part of the inductive energy to the decoupling capacitor, further reducing the energy delivered to the output to minimize the resultant voltage overshoot.

In another embodiment, the low side switch of the bridge arm of the converter utilizes a GaN device to control the conduction voltage drop across the switch by adjusting the voltage level of its gate drive signal during reverse conduction mode of the device, and thus adjusting the dissipation of the energy stored in the inductor during the freewheeling period to further suppress the voltage overshoot of the output at load step down transient.

These and other objects and advantages of the present invention will become more apparent from the following description taken in conjunction with the accompanying drawings. It is to be understood that with the principles as taught herein, the invention may be embodied or carried out in a manner that achieves or optimizes one advantage or group of advantages with different combination of the design and operating parameters.

### BRIEF DESCRIPTION OF THE DRAWINGS

FIG. 1A describes a typical conventional Buck converter circuit with a diode at low side to provide freewheel path for the inductor current. FIG. 1B shows a conventional synchronous Buck converter circuit with a MOSFET switch at low side to reduce the conduction loss.

FIG. 2 illustrates a conceptual circuit example of the invention.

FIG. 3 illustrates typical operating waveforms for explanation of the principle of the present invention.

FIG. 4 describes the operating state of the switches in the example circuit with a novel method to suppress output voltage overshoot at load step down transient.

### DETAILED DESCRIPTION OF THE INVENTION

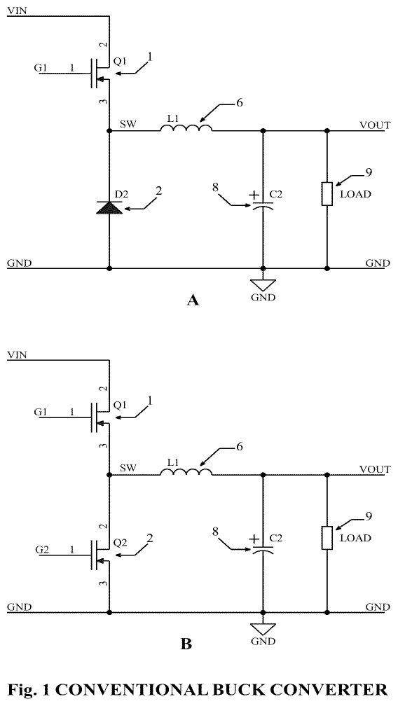

FIG. 1A and FIG. 1B have illustrated conceptual conventional Buck circuits. As well understood by those skilled in the art, the disadvantages of losses and noise associated with hard switching, losses and noise due to reverse recovery of the low side diode, including either the discrete diode in Fig. A or the body diode of the low side switch in FIG. 1B, and the high RMS current of high side switch at narrow duty cycle etc. have long been tough challenges facing design engineers. These challenges are well understood and analyzed in numerous articles, and hence will not be elaborated herein. These challenges are becoming more significant with the increasing current demand and increasing input to output voltage ratio with today's industry trend and thus have inspired the motivation of this invention.

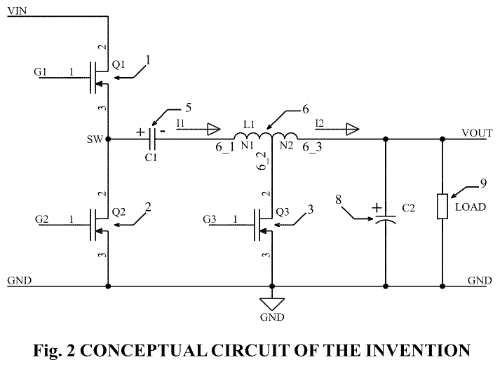

FIG. 2. illustrates an example circuit of the concept of the present invention. As shown in FIG. 2, a bridge arm consists of a high side switch 1, represented by an N type MOSFET as an example, and a low side switch 2, also represented by an N type MOSFET as an example, the positive terminal of the high side switch 1 is connected to the positive terminal of the input voltage VIN, the negative terminal of 1 and positive terminal of low side switch 2 is connected together to form a switching node SW, and the negative terminal of 2 is connected to the negative terminal of input voltage that also serves as the reference ground GND of the system; A tapped inductor 6 with its terminal 6_1 on the left side, center tap 6_2 in the middle, and terminal 6_3 on the right side, the first section with N1 turns between terminal 6_1 and 6_2, and the second section of N2 turns between terminal 6_2 and 6_3; A capacitor 5 with its first terminal on the left side connected to the switching node SW, and the second terminal on the right side connected to terminal 6_1 of inductor 6; A switch 3, represented by an N type MOSFET as an example, with its positive terminal connected to the center tap 6_2 of inductor 6, and the negative terminal connected to GND; The third terminal 6_3 of inductor 6 is connected to the positive terminal of filter capacitor 8 and positive terminal of load 9 to form the output node VOUT of the converter, the negative terminals of 8 and 9 are connected to reference ground GND. By default, a control unit will provide closed loop regulation for the output voltage of the converter by controlling the switching actions of switch 1, 2 and 3. Such approach is well understood by those skilled in the art and hence for simplicity of the description, will not be further elaborated herein.

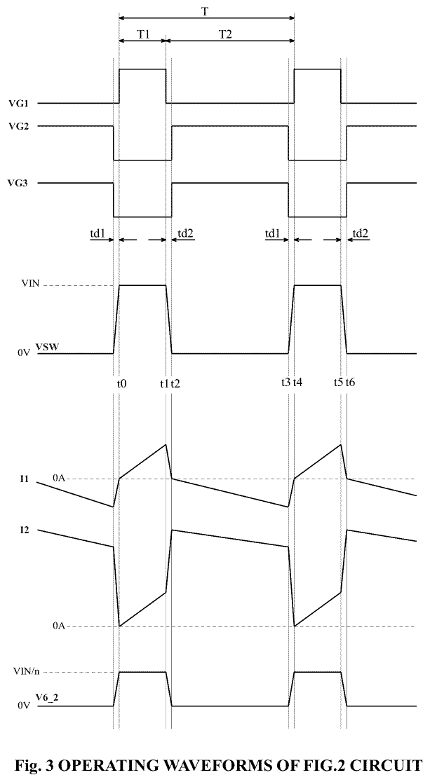

The control method of the switches and the associated waveforms are illustrated in FIG. 3. As shown in FIG. 3, high side switch 1 works as control switch to actively control the energy flowing from the input terminal VIN, the on and off operation of switch 2 and switch 3 is in complementary manner to switch 1, i.e. when switch 1 is on, switch 2 and 3 are off, and when switch 1 if off, switch 2 and 3 are on. In order to prevent shoot through situation, a dead time td1, during which the gate drive signals of all the switches are at off state, is inserted at the switching transition when switch 1 is turned on after switch 2 and 3 are turned off, and vice versa, a dead time td2 is inserted at the switching transition that switch 2 and 3 are turned on after switch 1 is turned off. Here td1 and td2 may have different values to get optimum result of the switching control.

During operation, when switch 1 is turned on, current flows from VIN through switch 1, capacitor 5 and inductor 6 to the output terminal VOUT to charge capacitor 8 and supply current to load 9, capacitor 5 is also charged by the current flowing through it, establishing the voltage across it with the polarity of positive on its left side terminal. During this period because switches 2 and 3 are off, tapped inductor 6 essentially works as a single inductor, the current of its two winding sections are equal, and the current flowing through to the output terminal VOUT is determined by its inductance and the values of VIN, VOUT, and the voltage across capacitor 5. If the capacitance of capacitor 5 and capacitor 6 are sufficiently large so that the voltages across them are maintained nearly constant at steady state switching operation, the current of inductor 6 approximately rises linearly during this period, indicated as T1 in FIG. 3.

At the end of active duty T1, switch 1 is being turned off at t1 by its gate drive signal VG1, for simplicity the turn off delay time of switch 1 is neglected herein. When switch 1 is turned off and before switches 2 and 3 are turned on, the current I1 flowing in the first section of inductor 6, i.e. the section between terminal 6_1 and 6_2, is cut off, because the stored magnetic energy in inductor 6 cannot change instantly, the energy stored in the first section of inductor 6 is transferred to the second section between 6_2 and 6_3 through magnetic coupling mechanism of the inductor, resulting a sharp decrease of I1 and sharp increase of I2.

Such sharp energy transfer is approximately a step change function. If we assume the first section of inductor 6 has N1 turns, and the second section of inductor 6 has N2 turns, a turns ratio n of the coupled inductor is defined as

n=(N1+N2)/N2 (1)

and as indicated in FIG. 3 that the current flowing in the first section of inductor 6 is I1, and the current flowing in the second section of inductor 6 is I2,
The changes of I1 and I2 can be approximately described as:

I1(t1)=I2(t1) (2)

Where t1—is the moment right before switch 1 is turned off

And I1(t2)=0, I2(t2)=(1+N1/N2)·I2(t1)=n·I2(t1) (3)

Where t2 is the moment right before switches 2 and 3 are turned on. Note that the changes of I1 and I2 herein are described approximately as sharp slopes instead of a step function with infinite slew rate to simplify the explanation without deviating from the spirit and principle of the present invention, and also assumes that td2 is set at an ideal value that the potential of switching node SW is swinged to near ground level at t2, at which moment switches 2 and 3 are turned on.

When switches 2 and 3 are turned at t2, the voltage of capacitor 5 V_{C1} is applied to the first section of inductor 6 through switches 2 and 3 with its center tap 6_2 seeing the positive voltage of capacitor 5. Under such condition the tapped inductor 6 becomes an autotransformer, the first section between terminal 6_1 and 6_2 becomes primary winding energized by the voltage from capacitor 5 with 6_2 impressed by positive side and 6_1 impressed by negative side of the voltage, and the second section between terminal 6_2 and 6_3 becomes secondary winding with an induced voltage positive on terminal 6_3 and negative on terminal 6_2 with the amplitude of (N2/N1)·V_{C1}, and further, the current generated by the transformer mode flows out from terminal 6_3 to capacitor 8 and load 9, and return to terminal 6_2 through switch 3, thus transfer the energy from capacitor 5 to the output terminal.

If the capacitances of capacitor 5 and capacitor 8 are large enough so that the voltage across them can be held nearly constant during the operation, by ignoring the voltage drops on the DC resistance of inductor 6, the on resistances of switches 2 and 3, and the DC resistance of the current conduction path etc., a simplified equation at the above described operating condition can be established as below:

V_{OUT}=(N2/N1)·V_{C1} (4)

Further, with the principle of volt second balancing of inductive component, another equation can be established for the voltage across the first section of inductor 6 as below:

T1·[N1/(N1+N2)]·(V_{IN}−V_{C1}−V_{OUT})=T2·V_{C1} (5)

Where T1 is the on time of control switch 1 and T2 the off time of control switch 1, for simplicity of analysis, the dead time td1 and td2 are neglected herein.
By solving equations 4 and 5 as a simultaneous equation set, the relationship between the output voltage V_{OUT} and input voltage V_{IN} is established as below:

V_{OUT}=(D/n)·V_{IN} (6)

Where D=T1/(T1+T2), and n=(N1+N2)/N2

From equation 6, it is obvious that the operating duty D is expanded by n times in this invention compared with the conventional approach, and hence reducing the RMS value of the current conducted by switch 1. As well understood, in practical operation the errors caused by the neglected factors as described above will be compensated by fine adjustment of duty cycle D through the closed loop control of the converter operation.

During the time period between t2 and t3, the current I1 in the first section of inductor 6 flows from terminal 6_2 to terminal 6_1, exhibiting a negative value in accordance to the direction indicated in FIG. 2. When switch 2 and switch 3 are being turned off at t3, this negative current will charge up the output capacitance of switch 2 and discharge the output capacitance of switch 1, pushing the voltage of switching node SW up till the body diode of switch 1 is forward biased, while circulating to the input voltage source through the loop of capacitor 5, through the input source to GND, and return through the body diode of switch 3, if the voltage across switch 1 reaches 0V or near 0V when it is turned on at t4, a zero voltage switching is achieved. Further, because switch 2 is already at off state and there is no reverse current flowing through its body diode at t4, there is no diode reverse recovery and associated shoot through when switch 1 is turned on. On the other hand, when switch 1 is turned on at zero voltage condition, there are no voltage changes across switches 2 and 3 at the turn on transition, hence switching losses of all the three switching devices are eliminated.

Further, from equation 4, the voltage across capacitor 5 is (N1/N2)·V_{OUT} during operation. Based on this equation, the voltage stress across switch 3, which is the voltage of the center tap terminal V_{6_2}, during the active duty when switch 1 is on and switches 2 and 3 are off, equals:

V6_2=(V_{IN}−V_{C1}−V_{OUT})/n+V_{OUT}=V_{IN}/n (7)

With larger value of n, the voltage stress across switch 3 will be significantly lower than the input voltage. As well understood, with the same die size, the on resistance of power switching devices increases dramatically with the increase of its voltage rating, the reduced voltage stress of switch 3 allows to use lower voltage rating devices and hence much lower on resistance in the design, thus reducing the conduction losses and hence providing additional contribution to the improvement of the converter efficiency. Shch advantage becomes more significant with high input voltage, low output voltage and high output current applications.

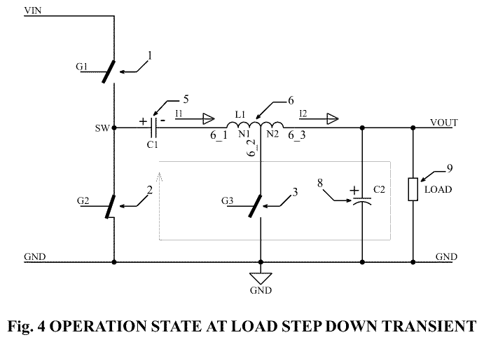

In addition, a fast response of the output voltage regulation at load transient, especially at load step down, can be achieved by a particular control method of the switching elements. FIG. 4 shows an example of the control method at a load current step down transient. As understood in conventional regulation control, at load step down transient the active duty of switch 1 will be reduced by the regulation loop, and at severe load step down transient the active duty of switch 1 may be reduced to zero, i.e. switch 1 turned off completely. At such condition, the converter does not receive additional energy from the input source. However, the current of inductor 6 continues its flow to the output with freewheeling action, and if the load current becomes lower than the inductive current I2 at the transient, the surplus current will be charged to capacitor 8 and push up the output voltage. Such situation is a challenge to the conventional Buck converter design but can be resolved more effectively with the circuit operation of this invention.

As shown in FIG. 4, under the situation described above, the invented control method keeps switch 3 off while switch 2 turns on after switch 1 is turned off. Because switch 3 is off, the tapped inductor 6 remains to be in inductor mode instead of working in autotransformer mode as described in paragraph [025]. At inductor mode I2 remains the same amplitude as I1 when switch 1 is turned off, instead of increasing to n times of I1 in transformer mode, and thus the current flowing to the output is much less, reducing the amplitude of V_{OUT} overshoot. In the meanwhile, when switch 3 is off, the circulation of the inductor current goes through the path of capacitor 8 and load 9, switch 2, and capacitor 5, so part of the inductive energy is transferred to capacitor 5 during the circulation, instead of totally delivered to the output, hence the energy delivered to output becomes less, further reducing output overshoot at load step down transient. Furthermore, if it is too strong to keep switch 3 fully off to the extent that causes a droop in the output voltage, the off time of switch 3 can be adjusted to be shorter by the closed loop control to maintain the output voltage regulation. With such control mechanism, switch 3 is operating partially off during the off period of switch 1.

In addition, a GaN device can be used as switch 2 to provide additional suppression for the output voltage overshoot. Because when GaN device is in reverse conduction mode, its conduction behavior is determined by the voltage level between its gate and drain, similar to forward conduction mode at which the voltage between gate and source controls its conduction behavior. With this in mind, if the gate threshold voltage of switch 2 is 2.5V and its gate voltage is held at 0V, the voltage drop across its drain and source has to be −2.5V or more negative when the reverse current flows through it from source to drain; and if the gate voltage is 1V, the voltage drop between drain and source of switch 2 has to be −1.5V or more negative to conduct the reverse current, thus the voltage drop across switch 2 during reverse conduction period after switch 1 is turned off can be controlled between −2.5V and 0V by holding its gate voltage between 0V and 2.5V accordingly. In this range the lower the gate voltage, the higher the reverse conduct voltage drop and hence the high energy dissipation, to more effectively suppress the output voltage overshoot at step down load transient. Note that for simplicity the GaN device described herein is treated as an ideal switch with the linear region around the gate threshold voltage neglected.

While certain embodiments of the inventions have been described, these embodiments are presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A DC-DC converter system comprising:
A bridge arm consists of a high side switch 1 and a low side switch 2, the positive terminal of said switch 1 is connected to the positive terminal of the input voltage, the negative terminal of said switch 1 and the positive terminal of said switch 2 are connected together to form a switching node SW, and the negative terminal of said switch 2 is connected to the negative terminal of the input voltage which is the reference ground of the system; A tapped inductor 6 with its first terminal 6_1 towards said switch node side, the second terminal 6_2 is the center tap, and the third terminal 6_3 is the output node of the converter, the first section between the first terminal 6_1 and second terminal 6_2 has N1 turns, and the second section between second terminal 6_2 and third terminal 6_3 has N2 turns; A capacitor 5 with its first terminal connected to said switching node SW, and the second terminal connected to the first terminal of inductor 6; A switch 3 with its positive terminal connected to the second terminal 6_2 of inductor 6, and the negative terminal connected to the reference ground; A capacitor 8 and a load element 9, with their positive terminals connected to the third terminal of inductor 6, which is the output node of the converter, and the negative terminals of 8 and 9 are connected to the reference ground; A control unit that provides closed loop regulation of the output voltage of the converter by controlling the switching operation of said switch 1, switch 2 and switch 3.

2. The DC-DC converter system of claim 1, wherein the output voltage is regulated by controlling the switching actions of said switches 1, 2 and 3, the on duty cycle of switch 1 controls the output voltage, the switching state of 2 and 3 is complementary to switch 1, when switch 1 is on, 2 and 3 are off, and when switch 1 is off, 2 and 3 are on, a dead time, during which the gate drive signals of all the switches are at off state, is inserted at the transitions of switching state change; During on period of switch 1, inductor 6 works in inductor mode, during on period of switches 2 and 3, inductor 6 works in transformer mode, during which the current direction in its first section is reversed while transferring the energy from capacitor 5 to the output, and when 2 and 3 are turned off, the current in the first section of 6 flows towards to the input voltage source, creating a zero voltage switching condition for the turn on operation of switch 1.

3. The DC-DC converter system of claim 1, wherein the voltage stress of switch 3 during its off time is reduced to 1/n of the input voltage, herein n is the turns ratio (N1+N2)/N2 of the tapped inductor 6, allowing the use of devices with lower voltage rating and associated lower conduction loss to improve the converter efficiency.

4. The DC-DC converter system of claim 1, wherein at load step down transition, switch 3 remains off or partially off with adjustable off time when switch 1 is off, preventing or partially preventing inductor 6 from entering transformer mode, to reduce the energy delivered to the output, and in the meanwhile, partially transfer the energy stored in inductor 6 to capacitor 5.

5. The DC-DC converter system of claim 1, use GaN device as said switches 2, wherein at load step down transition, adjust the voltage drop of switch 2 by controlling the voltage level of its gate drive signal when switch 1 is off, to provide adjustable dissipation of the energy stored in inductor 6 during its inductive current circulation, thus reducing the energy delivered to the output in a controlled manner.
